(19) United States
(12) Patent Application Publication
(10) Pub. No.: US 2004/0172350 A1
(43) Pub. Date: Sep. 2, 2004

(54) System and method for cross funding of multiple annuity contracts

(76) Inventors: Landis Atkinson, Richmond, VA (US); Mary Fay, Glastonbury, CT (US); Paul Haley, Glen Allen, VA (US); Vickey Root, Richmond, VA (US); Matthew Sharpe, Glen Allen, VA (US); Holly Snyder, Moseley, VA (US); Geoffrey Stiff, Richmond, VA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/294,820

(22) Filed: Nov. 15, 2002

(51) Int. Cl. G06F 17/60

(52) U.S. Cl. 705/35

(57) ABSTRACT

A process for cross funding of multiple annuity contracts is provided wherein a funding annuity contract is used to fund another annuity contract. The funding annuity contract may be used to transfer funds to the another annuity contract in multiple transfers.

### BACKGROUND OF THE INVENTION

Up until about 1870, more than half of the United States' adult workers were farmers. These adult workers were typically engaged in their occupations until their deaths or until their health prevented them from continuing their occupations. It was uncommon to have a prolonged retirement period before a worker's death.

After 1870, however, industry developed rapidly and the economy tended increasingly to be characterized by industrialization and urbanization. The result was that workers increasingly were employed in more industry-related jobs and became more dependent upon a continuing flow of monetary income to provide for themselves and their families. Additionally, the average life expectancies of workers began to increase significantly. It became more common for workers to retire from employment and survive for longer periods of time following their retirements. Retirement programs began to take hold. The Social Security program was introduced in 1935 and had an old age insurance component which provided a lump sum benefit for workers at age 65. At that time, the average life expectancy of a worker was 68.

Currently, however, half of male workers reaching age 65 can expect to still be alive at age 82 and half of female workers reaching age 65 can expect to be alive at age 86. The Social Security program is not keeping pace with such changes. The number of employees entering the workforce has been less than the number of new retirees for the last several years and this trend is expected to increase as the “Baby Boomers” age. The Social Security Administration (“SSA”) projects a shortfall in its trust fund which provides benefits to retirees beginning in 2013. The SSA believes that an immediate and permanent increase of social security payroll taxes is necessary in order to enable it to pay for the full amount of old age benefits it currently provides retirees. Now, employees and employers contribute approximately 12.4 percent of salaries to the Social Security trust fund. The SSA projects that contributions must be increased to at least 38 percent in order for its trust fund to remain fully funded. Therefore, it is becoming increasingly uncertain whether the Social Security program will continue to remain viable until the time that today's workers are ready to retire.

Moreover, many retirees have found that the amount of retirement benefits to which they are entitled under the Social Security program is insufficient to enable them to maintain a desired level of comfort in their retirement. They have found a need to supplement such Social Security benefits with income from other sources.

In addition to the institution of the Social Security program in the 1930s, beginning in the early 1900s, it became increasingly more common for employers to provide their workers, or employees, with some sort of retirement benefits or pensions. These retirement benefits or pensions were originally designed, in part, to reward an employee for his/her long career with a company and to help provide an income once such employee retired. Such retirement benefits or pension plans therefore required minimum periods of employment before an employee's entitlement to the pension amount became vested. However, many such retirement benefits or pensions are not portable. In other words, if an employee leaves the employ of an employer, that employee may lose all entitlement to such retirement benefits or pension if the employee terminates his/her employment prior to the expiration of the vesting period. This was not a problem when employers first instituted such retirement benefits or pension plans as employees tended to remain employed with one employer for their entire careers until they retired.

However, in today's mobile society, employees do not tend to remain employed by one employer for their entire careers. Many employees therefore lose some or all of their projected retirement benefits which may have accrued during their employ by their employers when they leave the employ of such employers.

Furthermore, in addition to the trend of a more mobile society and an increased level of employment changes, many employers are increasingly turning to non-employee labor in part to cut expenses resulting from employee benefits such as costs related to funding employee retirement plans. Thus, many individuals in the workforce today are technically not considered “employees” but instead are independent contractors for whom employment benefits are not provided. Additionally, many employers are ceasing to offer defined benefit plans altogether because of the costs. In fact, according to statistics published by the Pension Benefit Guaranty Corporation, defined benefit pension plans of employers have decreased by more than 60 percent since 1985, with the number of U.S.-based employers that offer such defined benefit pension plans decreasing from 114,000 in 1985 to less than 40,000 in 1999. Only 21.3 percent of working family heads are currently covered by an employer-funded defined retirement benefit or pension plan.

Because of the decrease in the number of employers that offer defined retirement benefit pension plans, the decrease in the number of workers entitled to employer-funded retirement benefits and also because of the increased mobility of the workforce resulting in the loss of such employer-funded benefits, many workers have started to fund their own retirement savings plans. Tax laws have enabled workers to realize tax benefits from deferring their income by putting amounts from their paychecks into such retirement savings plans. Increasingly, such employee-self-funded retirement savings plans are becoming the primary sources of income on which employees survive following retirement.

However, one disadvantage of the increased reliance upon employee-self-funded retirement savings plans is that these plans do not provide a level of retirement income that is guaranteed for the employee. In addition, many employees do not have any idea of an amount required to be saved in order to achieve a desired level of income to ensure a comfortable lifestyle upon their retirement. Thus, they do not contribute a sufficient amount of their salaries towards such retirement savings to provide an adequate income level to maintain the standard of living they desire upon retirement. Based on the results of the Retirement Confidence Survey sponsored by the Employee Benefits Research Institute (EBRI), the American Savings Education Council (ASEC), and Matthew Greenwald and Associates, 22 percent of all employed adult workers have saved less than $10,000 towards retirement, 50 percent have saved less than $50,000 and only 25 percent of adult workers over the age of 55 have accumulated more than $100,000.

Retirement income needs may increase in the event such retirees suffer from health-related problems. In fact, many employees today express concern that they will not have adequate funds saved to provide for themselves during retirement in the event they suffer health-related problems after they retire. They are currently seeking some means to ensure a higher level of income saved for such crises.

Employees often do not participate in their employer-sponsored retirement savings plans which will increase the level of their savings through interest income or a return on investment. Also, many individuals lack the sophistication needed to determine the appropriate type of investment vehicle which will offer them a high return on their investment but which is also secure enough so that their savings are not placed at risk by a high-risk type of investment vehicle.

Thus, there is a need for an investment vehicle which will provide a minimum retirement income which is portable so that a worker will not lose any income vested in a fully funded investment vehicle if the worker leaves the employ of an employer or changes jobs.

There is also a need to provide a defined retirement benefit which will guarantee an individual a minimum defined income level upon the individual's retirement.

Heretofore, there has not been a retirement investment vehicle which enables an employee to obtain the benefits of participation in the equity market while also enabling the employee to reallocate investments among annuity contracts on an at-will basis or based on certain environmental triggers, such as during a recessionary period when the equity markets are performing poorly or other similar factors. Thus, there is a need for such a retirement investment vehicle.

Additionally, there is a need for a retirement investment vehicle which may provide a guaranteed minimum level of retirement income and also may afford an individual an opportunity for an increase in value of the benefits provided if market performance of the retirement investment vehicle exceeds a predefined benchmark.

Moreover, many employees may desire to exchange or transfer some of their retirement savings or assets from one type of annuity into another type of annuity. However, heretofore, there have not existed the means to transfer funds in multiple transactions from one type of annuity to fund another type of annuity in a manner which minimizes adverse tax consequences to the employee. Thus, there is a need to provide a means to transfer funds from one type of annuity to enable an employee to fund such other type of annuity in a manner which minimizes the adverse tax consequences.

### BRIEF SUMMARY OF THE INVENTION

The above-described problems and needs are addressed by the system and process of the present invention. According to one embodiment of the invention, a process for cross funding of multiple annuity contracts is provided, wherein a funding annuity contract is used to fund another annuity contract. The funding annuity contract may be used to transfer funds to the another annuity contract in multiple transfers. The process comprises the steps of identifying multiple annuity needs of a user; selecting an annuity type to meet each of the user's multiple annuity needs; the user entering into an annuity contract for each selected annuity type with an issuer company; the user declaring an intent to combine the multiple annuities and treating the multiple annuities as one annuity for purposes of tax treatment; combining the multiple annuities for accounting; purchasing the funding annuity contract to be used to make the multiple transfers between the annuity contracts; and, following expiration of an accumulation period, making periodic annuity distributions to the user from each of the annuity contracts.

The accompanying drawings, which are incorporated in and constitute a part of this specification, together with the description, serve to explain the principles of the invention.

### BRIEF DESCRIPTION OF THE DRAWINGS

FIG. 1 is a flow diagram illustrating one embodiment of a process for cross funding of annuity contracts; and

FIG. 2 is a block diagram illustrating one embodiment of a system for cross funding of annuity contracts; and

FIG. 3 is a block diagram illustrating one embodiment of a system for providing a user with periodic retirement payments.

### DETAILED DESCRIPTION OF THE INVENTION

Reference will now be made in detail to the present preferred embodiments of the invention, examples of which are illustrated in the accompanying drawings in which like reference numerals refer to corresponding elements.

The present invention is described in relation to a process for cross-funding of multiple annuity contracts. Nonetheless, the characteristics and parameters pertaining to the systems and methods may be applicable to other types of financial instruments.

An annuity is a flexible tax-deferred retirement investment product that can provide long-term earnings for an investor (“user”). An annuity allows a user's retirement savings to grow on an income tax-deferred basis and allows the user to choose a payout option that best meets the user's need for income when the user retires. Payout options may include a lump sum payment, a plurality of periodic payments, income for a remainder of the user's life, or a plurality of income payments paid out over a certain period of time.

When a user purchases an annuity, also known as a long-term investment contract, the user typically pays an insurer an initial sum of money (called a premium or principal) and the insurer invests that principal in an investment type of financial product to earn a return on that principal. In return for the initial sum of money, or premium payment, and the use of that initial sum of money, the insurer guarantees the user either a steady stream of income payments with no upside earnings potential or a stream of income payments adjusted for market performance (but generally not both) beginning at a specified date in the future and lasting for a specified period of time. While the premium payment is invested in the investment vehicle, the premium payment grows or compounds over time, but the user does not have to pay any taxes on the earnings. This phase of an annuity contract is referred to as an accumulation period. Once the user has accumulated an amount of money the user requires for retirement, the user can begin to receive periodic income payments made from the accumulated investment premium. Only when the user begins to receive payments are the monies subject to taxes. One disadvantage to a typical annuity contract, however, is that it has a specified date which, if the user wishes to withdraw his/her monies prior to such date, the user will be penalized and will have to pay the insurer a surrender charge (we will refer to this date as the “surrender charge period date”). Additionally, if the user withdraws his/her money out of the annuity investment vehicle prior to age 59 1/2 years, other than as a series of periodic payments, the Internal Revenue Service also requires payment of a penalty since he/she had obtained the benefit of tax-deferred treatment during the time the monies were invested.

There are several standard types of annuity contracts which insurers offer. A fixed annuity is an annuity where the insurer guarantees the user the invested principal value and a payment of a fixed rate of return for a stated period of time on the premium payment invested during the accumulation period and a guaranteed income for life if the user “annuitizes” or converts the annuity into a stream of regular income payments. The insurer takes responsibility for investing the user's premium payment in whatever types of financial products it believes will earn enough income to enable it to meet its obligations under its guaranteed rate of return to the user. Assuming that the user holds the annuity contract until after the surrender charge period date, the benefit of such a fixed annuity contract to the user is in having a guaranteed income payment stream over a long period of time. The user is essentially betting that he/she will live a longer period of time than expected and will therefore realize a substantially higher amount of money in the guaranteed income payments than the initial premium payment. On the other hand, the insurer is betting on the opposite scenario, i.e., that it can make favorable investments of the premium payments which result in increased earnings and that the users, as a class, will not live longer than expected.

A variable annuity is a contract in which the premiums paid are invested in one or more stock and bond sub-accounts. A variable annuity account value reflects the performance of the investment sub-accounts or funds selected. Over the long-term, premiums invested in equity stock funds generally reflect the growth and performance of the economy and can serve as a hedge against inflation.

A deferred annuity contract is generally one in which one or more annuity payouts begin at a future date. An immediate annuity contract is generally one in which annuity payouts begin immediately or within one year.

Fixed deferred annuities are popular because of their safe and predictable rates of return. Insurers often place fixed annuity contract premium payments into bonds or other conservative types of investment vehicles. Since fixed deferred annuities guarantee a specific return on the initial investment and a guaranteed return of principal, they are attractive to potential investors when the equity stock market is under-performing and interest rates are on the rise. However, under fixed deferred annuity contracts, the user is generally not advised of and does not participate in the insurer's investment choices and thus has to trust the insurer to make wise investment decisions. Moreover, the popularity of fixed annuity contracts over variable annuity contracts, and vice versa, is dependent on the economic cycle and the stock market's performance. In a “bull” market, variable annuities generally tend to be preferred, and in a “bear” market, fixed annuities tend to be preferred. Also, variable annuities may be preferred by users who have a longer period of time until retirement, whereas, as users age, they may be more inclined to select a more conservative investment such as a fixed annuity.

With a variable deferred annuity contract, the user can decide how his/her premium payment will be allocated among a specific menu of investment vehicles, or sub-accounts, offered by the insurer. Sub-accounts are pooled investments of a number of users, similar to mutual funds, with varying investment objectives and strategies and typically have a professional fund manager similar to managers of mutual funds. The manager of the sub-account will decide where to invest the pooled funds based upon the objectives of the particular sub-account, e.g., growth, emerging industries, bonds, etc. The accumulated monies in the annuity contract of the user fluctuate with market values and with the user's choice of sub-accounts.

Variable deferred annuities have advantages over fixed deferred annuities since they enable the user to direct how his/her premium payment will be invested among one or more sub-accounts. Moreover, variable deferred annuities could potentially enable the user to earn more money on the initial investment than he/she could with a fixed deferred annuity contract if the user selected strong sub-accounts with high rates of return on investment. However, the variable deferred annuity contract makes no guarantees to the user regarding the amounts earned on the premium invested, the value of invested principal or the income amount to be paid out after the accumulation period, so the user could also potentially end up earning less money than desired if the sub-accounts selected by the user are weak or perform poorly. Since the value of the variable deferred annuity is tied to the risks inherent in the stock market, a downturn in the stock market could cause the value of the variable deferred annuity to drop. Thus, variable deferred annuities are not desirable to those users who are risk averse.

Another type of annuity is a modified guarantee annuity. This is a market value annuity with a fixed rate of return if the annuity is held for a stated period of time. However, if the user surrenders the annuity prior to the end of the accumulation period, the amount of monies paid out will be based on changes in interest rates since purchase or the market value at the time of withdrawal.

There are also fixed immediate annuity contracts. Purchasing a fixed immediate annuity requires a lump sum premium payment. The amount of retirement income is determined at the time of purchase and the retirement income can be paid out over the life of the user, over a certain period of time, or over a combination of the two. Retirees often purchase a fixed immediate annuity with funds they receive from 401(k) plans, Individual Retirement Accounts (“IRAs”), savings account funds, the cash value or death proceeds from a life insurance policy or proceeds from the sale of a home. The insurer issuing the fixed immediate annuity guarantees payments directly to a user on a monthly, quarterly, semi-annual or annual basis for the life of the user, for a certain period of time, or for some combination of the two. At the time of purchase, the income payments are locked based upon current market interest rates. The user's income payments are determined by, among other things, a combination of the market interest rate, the payment options selected by the user, the premium payment amount and the life expectancy of the user. Once the lump sum premium payment is made, the user has exchanged the lump sum premium payment for a series of guaranteed payments that will not change as a result of market performance. With a fixed immediate annuity, the user does not have any input concerning how the lump sum premium payment is invested.

A variable immediate annuity, like a fixed immediate annuity, guarantees income over the life of the user, for a certain period of time, or for a combination of the two. However, unlike a fixed immediate annuity where the income payments are fixed and do not vary, the income payments received from the variable immediate annuity vary based on market performance. The user could potentially earn more or less on a variable immediate annuity because of the equity investments.

As described above, many users purchase annuities by making a lump sum payment, such as by using funds from the user's 401(k) plan, IRA, savings account funds, the cash value or death proceeds from a life insurance policy or proceeds from the sale of a home.

However, a user having a pre-existing annuity contract might be interested in exchanging the funds available in an annuity contract associated with this pre-existing annuity contract for another type of annuity contract. For example, a user may have a fixed annuity and may desire to purchase a variable annuity. However, in order to exchange a pre-existing annuity contract for another type of annuity contract, the user would likely need to obtain the cash surrender value from the user's pre-existing annuity contract and place the cash surrender value transferred from the pre-existing annuity contract in another annuity contract in multiple transfers. However, the user may suffer surrender charges in the pre-existing contract and Internal Revenue Service penalties due to obtaining the cash surrender value of the pre-existing annuity contract prior to the end of the contractual accumulation period in order to fund the purchase of another type of annuity contract.

Additionally, a user having a lump sum of money that the user wishes to invest in an annuity for retirement income may have multiple income needs which may change over time. For example, if the user is young, the user may be more willing to invest in a variable annuity. However, as the user ages, the user may desire more stable types of investments with guaranteed returns. Thus, a fixed annuity may become more desirable. Previously, however, it has not been possible to make multiple transfers of funds between multiple annuity contracts without suffering adverse tax consequences. Current processes and systems accommodate only a single transfer, either full or partial, on the initial purchase of an annuity. The processes and multiple systems of the present invention overcome such deficiencies in the prior processes and systems.

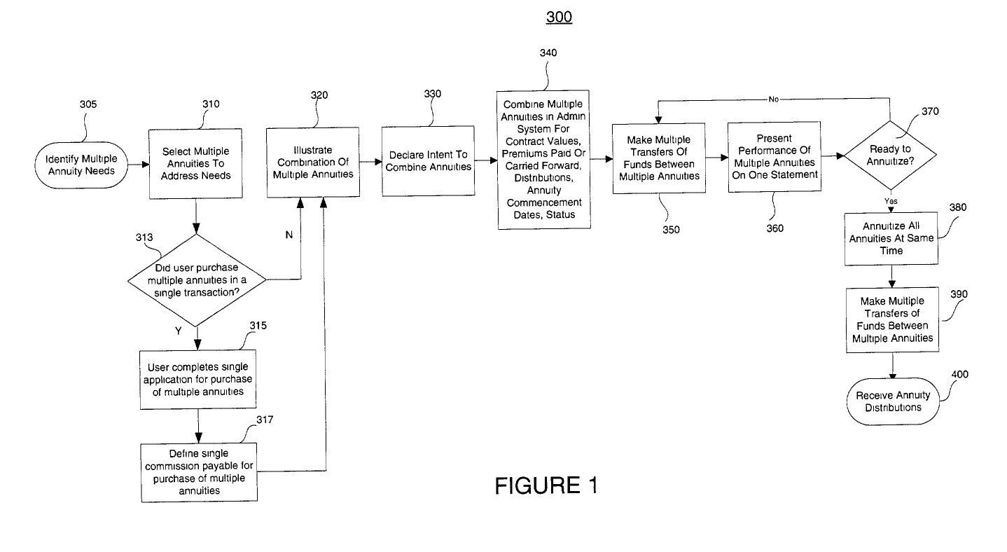

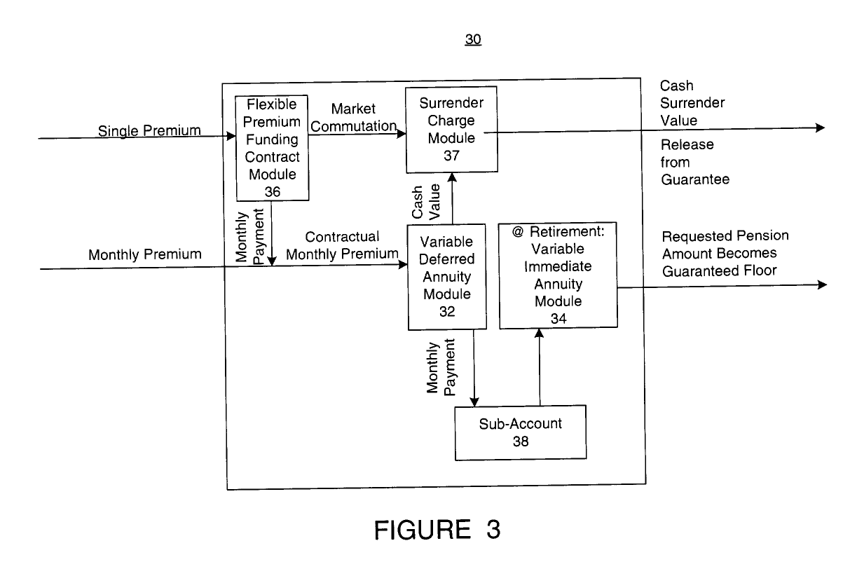

FIG. 1 is a flow diagram illustrating one embodiment of a process 300 for cross funding of multiple annuity contracts. The process 300 begins at step 305, with the company and/or the user identifying multiple annuity needs of the user. For example, a user may have a need, upon the user's retirement, to receive guaranteed minimum payment amounts on a periodic basis, and the user may also have a need to invest a lump sum in an investment vehicle which will defer the user's taxes on the lump sum. At step 310, the company and/or the user select multiple annuities to address the user's needs. For example, in order to address the user's needs for guaranteed minimum payment amounts upon the user's retirement, a portable guaranteed retirement annuity is selected. One type of portable guaranteed retirement annuity may provide a guaranteed payment stream in a manner similar to a fixed immediate annuity, an upside potential for a return on investment during the accumulation period in a manner similar to a variable deferred annuity, and a potential to realize an increased retirement income amount based on equity market performance in a manner similar to a variable immediate annuity. (The portable guaranteed retirement annuity is described in greater detail below with reference to FIG. 3.) It should be noted that although a portable guaranteed retirement annuity is described, this is for purposes of illustration only. The cross funding process and system of the present invention may be used in connection with multiple annuities of any type including qualified and non-qualified contracts. The annuity types should be selected based upon the investment, income and retirement needs of the particular user, as well as the age and health of the user. Other factors which should be weighed in selecting the annuities include differences in death benefits provided under the annuity contracts, differences in income benefits, optional riders, etc. One of the benefits of the process 300 is that it enables the user and the company to customize the package of annuities to fit a particular user's particularized needs. Prior to this invention, most insurers only offered annuities to users that by their contractual terms did not enable investment strategies to be modified or funds to be moved more than once between annuity contracts once the annuities were purchased.

With reference again to step 310 of process 300, in order to achieve tax-deferred treatment for the user's lump sum, and to fund the required premium payments for a portable guaranteed retirement annuity, another annuity is selected as the funding annuity. If the user has a relatively lengthy time frame prior to when the user wishes to retire, the user may be willing to invest the lump sum in a variable deferred annuity which includes equity-based sub-accounts as the funding annuity for transferring the required premium payments for the portable guaranteed retirement annuity. If the user is closer to retirement age and is therefore risk adverse, then the user may wish to use a fixed deferred annuity as the funding annuity.

The next step 320 in the process 300 is to “illustrate” the combination of annuities selected by the user to ensure that they will meet the user's investment and income goals.

At step 330, the user declares an intent to “combine” the annuities to treat them as one annuity in order to receive favorable tax treatment. In order for a user to declare the annuities as one, the annuitant(s) must be the same person(s) under the annuity contracts, the owner(s) must be the same person(s) under the annuity contracts, and the annuity contracts must annuitize in conjunction with each other and preferably the annuity commencement date, i.e., the date on which income payments may commence, must be the same date under the annuity contracts. It is also preferable that the annuity contracts be purchased at the same time for ease of administration and that the annuity contracts be issued by the same issuer company and there be an integrated administration platform whether or not the issuer companies are the same, but this is not a requirement in order to treat the annuity contracts as one.

The user's declaration does not preclude the user from subsequently changing the annuity commencement date of the funding annuity or accelerating the annuitization of the other annuity contract. However, the declaration puts the user on notice that changing the annuity commencement date of the funding annuity or accelerating the annuitization of the other annuity contract may subject the user to adverse tax consequences.

At step 340, after the user's declaration, the company combines the selected annuities in its administrative system in order to aggregate the contract values of the annuity contracts, the amount of premiums to be paid under the annuity contracts, the distribution amounts and to ensure the annuity contracts annuitize in conjunction with one another and initially have the same remaining accumulation periods. It is preferable that the annuity contracts annuitize on the same day, but it is not required.

At step 350, the user's lump sum which was used to purchase the funding annuity is used to make multiple transfers between the multiple annuity contracts based on the user's investment needs. At step 360, the company may present the performance of the selected annuities on a single statement to the user in a periodic manner. For example, this single statement may calculate a combined death benefit for the annuity contracts. It may track transfers of funds made between the annuity accounts. It may track withdrawals made by the user from the annuity contracts. And, it may report on other similar matters.

At step 370, a determination is made as to whether, pursuant to the terms of the annuity contracts, the accumulation period has expired and the contracts are ready to be annuitized. If the accumulation period has not expired, the process 300 loops back to step 350. If the accumulation period has expired, then the process 300 proceeds to step 380 and the annuity contracts are annuitized in conjunction with one another.

At step 390, the process 300 may make multiple transfers of funds between the annuity contracts. For example, at a point in time, the user may wish to transfer funds from a more volatile equity-based annuity contract to a more conservative annuity contract. Or, the user may establish conditions for transfer of funds between the annuity contracts which are based upon certain triggers or environmental factors, for example, the performance of the equity markets. The process 300 of the present invention contemplates that a user may make multiple transfers of funds between the annuity contracts on an at-will or a systematic basis. The process 300 is flexible so that the user's annuity contracts and the investments therein may be modified over the accumulation period to reflect the user's changing needs as the user approaches retirement. As an illustrative example, if the stock market is experiencing long-term sustained losses, the user may wish to transfer funds from a variable annuity contract into a more stable fixed annuity contract.

At step 400, following expiration of the accumulation period, the user may receive periodic income distributions from the annuity contracts.

In order to facilitate the administration of these “combined” annuities, the process 300 may optionally further include, in situations in which the user purchases the annuities in a single transaction (as determined in step 313), a step 315 following step 310 wherein the user completes a single application for the purchase of the selected annuities. Additionally, at a step 317 following step 315, the issuer may define a single commission payable for the combined purchase of the selected annuities.

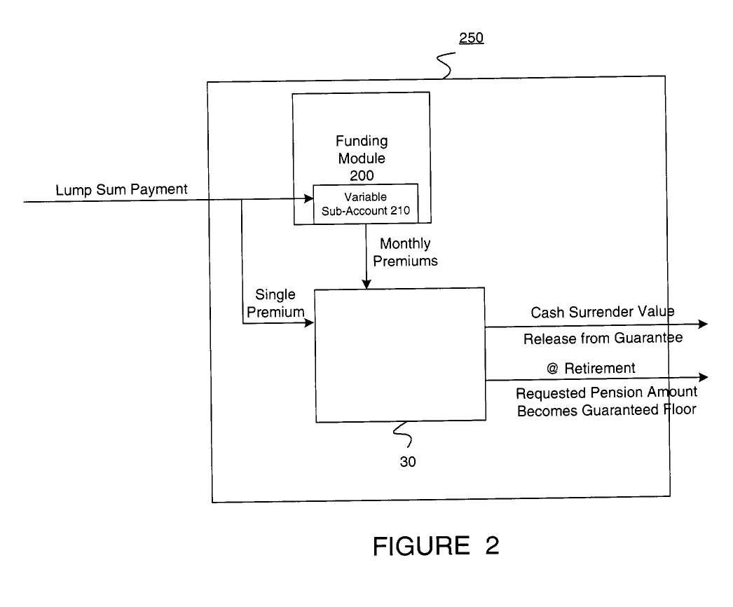

A system 250 utilizing the process 300 of FIG. 1 is shown in FIG. 2. As illustrated in FIG. 2, a user having a pre-existing annuity contract the user wishes to exchange for an investment in another type of annuity contract, or a user having a lump sum that the user wishes to invest in an annuity, may purchase (1) an annuity contract (shown as a portable guaranteed retirement annuity module 30 as an illustrative example), and (2) another variable annuity contract (a “funding annuity” shown as funding annuity module 200). In this embodiment, monetary amounts will be transferred from a variable sub-account 210 of the funding annuity module 200 to the annuity module 30 to satisfy the scheduled monthly premium payments called for under the contract for annuity module 30. Pending the transfer of funds to the annuity module 30, the user may choose one of a plurality of investment options available for the variable sub-account 210 of the funding annuity module 200, including a plurality of equity-based investment options. If module 30 is a portable guaranteed retirement annuity, the guarantee of a minimum level of income payments only applies to amounts accumulated under the annuity module 30, and not to amounts invested in the variable sub-account 210 of the funding annuity module 200, thus any investment risks associated with the investment options selected for the variable sub-account 210 of the funding annuity module 200 are borne by the user. However, the availability of multiple investment options for the amounts in the variable sub-account 210 of the funding annuity module 200 enable the user to customize the characteristics of the funding annuity module 200 and have the investment flexibility desired by the user.

In one embodiment, the user may purchase the annuity contract for annuity module 30 and the funding annuity contract for funding annuity module 200 in a single transaction. Payment for the two annuities may be made with a single consideration, either in the form of a single lump sum payment or via the user's exchange of funds invested in a pre-existing annuity contract for the two annuities. The user may transfer amounts for the scheduled monthly premium payments called for by the annuity contract for annuity module 30 from the variable sub-account 210 of the funding annuity module 200 to the annuity module 30 when the scheduled monthly premium payments are due. The user may allocate the amounts held in the variable sub-account 210 of the funding annuity module 200 among the various investment options depending upon the amount of risk the user can bear and the return on investment desired by the user. In order to facilitate the administration of the exchange of a pre-existing annuity contract or a lump sum payment for the funding annuity contract and the annuity contract for annuity module 30, the funding annuity contract and the annuity contract for module 30 must have the same annuitant(s), same owner(s), must annuitize in conjunction with one another, and they should initially have the same remaining accumulation period. If these requirements are met, the annuity contracts may be “declared” by the user to be one annuity which may therefore be aggregated for tax purposes. The user may then make multiple transfers between the two annuity contracts as desired. It is preferable, but not required, that the two annuity contracts be purchased in a single transaction and that the contracts be issued to the user at the same time. However, a user may also purchase an annuity contract in a first transaction and a second annuity contract in a second transaction and may nevertheless make use of the system and process of the present invention. In order to do so, however, both annuity contracts must name the same annuitant(s), name the same owners(s), annuitize in conjunction with one another, and initially have the same remaining accumulation periods. The user must then “declare” the annuity contracts to be one annuity.

FIG. 3 is a block diagram illustrating one embodiment of an annuity module 30 (such as module 30 shown in FIG. 2) for providing a user with a plurality of periodic retirement income payments. In this embodiment, the module 30 may be a portable guaranteed retirement annuity. The portable guaranteed retirement annuity module 30 may further include a variable deferred annuity (“VDA”) module 32 and a variable immediate annuity (“VIA”) module 34. One or more premium payments received into the portable guaranteed retirement annuity module 30 may be placed into the VDA module 32.

In this embodiment, the contractual monthly premium payment may be deposited into a predetermined sub-account 38 of the VDA module 32. The predetermined sub-account 38 may mirror a pension fund management style. At completion of a contractual accumulation period, the monetary value invested in the predetermined sub-account 38 may be transferred to the VIA module 34 for payout to the user.

If the amount accumulated in the predetermined sub-account 38 is greater than an amount needed for a guaranteed minimum retirement income amount, the user may receive an amount greater than the guaranteed minimum retirement income amount during the annuity payout period. If the amount accumulated in the sub-account 38 is less than the amount required to achieve the guaranteed minimum retirement income amount, the company will pay the user an amount equal to the guaranteed minimum retirement income amount.

The user may choose to pay a single premium which fulfills the total premium payments to be paid over the annuity contractual accumulation period. In this embodiment, the single premium may be deposited into the funding annuity contract in a funding annuity contract module 36. Then, money from the funding annuity contract may be transferred to the user's VDA contract in the VDA module 32 periodically according to the terms and conditions included in the user's annuity contract for annuity module 30. For example, if the user has an annuity contract for module 30 requiring monthly premium payments, the user's entire monthly premium payment amount may be transferred to the user's VDA contract in the VDA module 32 at each of the preset payment intervals.

In one embodiment, the user's funding annuity contract may be used to buy-down an amount of the user's monthly premium payment amount for the module 30 annuity contract. In this embodiment, the same amount will be transferred from the user's funding annuity contract to the user's VDA contract every month until the end of the user's contractual accumulation period. Thus, if the user's monthly premium payment amount is $1,000 and the user's funding annuity contract is used to contribute $300 per month towards payment of that $1,000 monthly premium payment, the user will pay $700 a month in addition to the $300 amount contributed from the user's funding annuity contract.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as it is intended to be encompassed by the following claims and their legal equivalents.

What is claimed is:

1. A process for cross funding of multiple annuity contracts, wherein a funding annuity contract is used to fund another annuity contract, the process comprising the steps of:
a. identifying multiple annuity needs of a user;
b. selecting an annuity type to meet each of the user's multiple annuity needs;
c. the user entering into an annuity contract for each selected annuity type with an issuer company;
d. the user declaring an intent to combine the multiple annuities and treating the multiple annuities as one annuity for purposes of tax treatment;
e. combining the multiple annuities for accounting;
f. purchasing the funding annuity contract to be used to make multiple transfers between the annuity contracts; and
g. following an accumulation period, making periodic annuity distributions to the user from each of the annuity contracts.

2. The process for cross funding of multiple annuity contracts as claimed in claim 1 wherein the step of combining the multiple annuities for accounting includes the sub-steps of:
a. aggregating a contract value of each of the multiple annuities;
b. allocating a premium payment amount for each of the multiple annuities;
c. establishing an annuity commencement date for each of the multiple annuities such that each of the multiple annuities annuitize in conjunction with each of the other multiple annuities;
d. scheduling an accumulation period for each of the multiple annuities to be the same accumulation period;
e. annuitizing each of the multiple annuities in conjunction with each of the other multiple annuities; and
f. making periodic annuity distributions to the user from each of the funded annuity contracts.

3. The process for cross funding of multiple annuity contracts as claimed in claim 1 wherein the step of the user entering into an annuity contract for each selected annuity type comprises the user entering into the annuity contract for each selected annuity type simultaneously.

4. The process for cross funding of multiple annuity contracts as claimed in claim 1 wherein the step of the user entering into an annuity contract for each selected annuity type comprises the user entering into the annuity contract for each selected annuity type at different times.

5. The process for cross funding of multiple annuity contracts as claimed in claim 1 further comprising the step of making one or more transfers between the funding annuity contract to the another annuity contract, following the purchasing step, based upon pre-defined trigger events.

6. The process for cross funding of multiple annuity contracts as claimed in claim 1 further comprising the step of making one or more transfers between the funding annuity contract and the another annuity contract, following the purchasing step, on an at-will basis based upon the user's direction.

7. The process for cross funding of multiple annuity contracts as claimed in claim 5 wherein the trigger events include an age of the user, a value of funds in the funding annuity contract, or a value of funds in the another annuity contract.

8. The process for cross funding of multiple annuity contracts as claimed in claim 2 wherein the step of combining the multiple annuities for accounting further includes the sub-step of the issuer defining a single commission payable for the combined purchase of the selected annuities.

9. The process for cross funding of multiple annuity contracts as claimed in claim 1 wherein the purchasing step comprises the user making a lump sum payment.

10. The process for cross funding of multiple annuity contracts as claimed in claim 1 wherein the purchasing step comprises the user exchanging funds invested in a pre-existing annuity contract.

11. The process for cross funding of multiple annuity contracts as claimed in claim 1 wherein either of the annuity contracts may be the funding annuity contract for any of the multiple transfers.

12. The process for cross funding of multiple annuity contracts as claimed in claim 1 wherein the multiple annuity contracts are administered on an integrated system shared by each of the issuer companies.

13. A process for annuitizing a cross-funded annuity contract in conjunction with another cross-funded annuity contract comprising the steps of:
a. identifying multiple annuity payment needs of a user;
b. selecting one of the multiple annuity payment needs of the user as a preferred annuitization option;
c. the user transferring monies between the cross-funded annuity contracts to fund the preferred annuitization option; and
d. combining the multiple annuity payment needs for payment and accounting.

14. The process for annuitizing a cross-funded annuity contract in conjunction with another cross-funded annuity contract as claimed in claim 13 further comprising the step of annuitizing each of the cross-funded annuity contracts at the same time following the combining step.
